(19) United States
(12) Patent Application Publication
(10) Pub. No.: US 2004/0142088 A1
(43) Pub. Date: Jul. 22, 2004

(54) Frozen vegetable foods keeping texture after freezing and thawing

(76) Inventors: Masahito Kosaka, Tokyo (JP); Tsuyoshi Koriyama, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/472,192

(22) PCT Filed: Mar. 25, 2002
(86) PCT No.: PCT/JP02/02842

(30) Foreign Application Priority Data
Mar. 30, 2001 (JP) 2001-101487

(51) Int. Cl. A23K 1/00

(52) U.S. Cl. 426/615

(57) ABSTRACT

Frozen vegetables capable of keeping good texture after freezing and then thawing. Vegetables in which peroxidase has been inactivated or its activity is lowered by superheated steam. Vegetables in which peroxidase has been inactivated and which have been sterilized. Cooked vegetable foods suffering from less worsening in texture, which have been sterilized and in which peroxidase has been inactivated by a cooking treatment with the use of superheated steam. Cooked vegetable foods wherein the above-described worsening in texture is attributable to softening of the texture, enhanced water release caused by separation and flowing out of water in chewing, and change into the porous and sponge-like form after freezing and then thawing. Frozen products of the vegetables or the vegetable foods described above, or thawed products thereof which are adaptable for distribution in a chilled state. The vegetables may be selected from the group consisting of eggplants, Welsh onions, beans, leaf vegetables and soft vegetables. The vegetables may be selected from the group consisting of paprika, asparagus, garlic buds, kidney beans, Chinese cabbages, onions, cabbages and broccoli.

### TECHNICAL FIELD

The present invention relates to techniques for processing vegetables by using superheated steam, which are adapted for providing, e.g., vegetables in which peroxidase has been inactivated by superheated steam, and frozen vegetable foods keeping good texture even after being subjected to the steps of blanching by superheated steam, freezing and then thawing.

In the present invention, the expression “peroxidase has been inactivated or its activity is lowered” means that the activity of peroxidase is reduced to such an extent as keeping vegetables from discoloring or smelling nastily with the action of peroxidase. The degree by which the activity of peroxidase is to be lowered can be selected as appropriate depending on the kinds of vegetables, a preservation manner of the vegetables, and a preservation period thereof.

In the present invention, the word “sterilized” means that vegetables have been sterilized to such an extent as being able to sell them as an ingestible frozen food without-heated.

### BACKGROUND ART

The number of kinds of vegetables which can be supplied in a whole year is limited, and the number of days during which vegetables can be kept fresh is relatively short. In addition, vegetables take a time for cooking and some parts of the vegetables are wastes.

On the other hand, by previously cutting vegetables into small pieces in the form edible as they are and freezing the cut vegetables, the above-mentioned disadvantages of vegetables can be overcome and the vegetables can be served at once onto dining tables in a whole year while the vegetables are kept in a fresh and hygienic condition. Further, for producers of vegetable processed foods, if frozen vegetables can be produced in a satisfactory state, the producers can more easily keep up with the price fluctuation of fresh vegetables. When producing the frozen vegetables, however, water in the texture is frozen in the freezing step, whereupon the size of ice crystals is increased and hence the texture is collapsed. The texture collapse causes various oxidizing enzymes, such as peroxidase and lipoxigenase, to react with the substrate. This reaction promotes the occurrence of nasty smelling and discoloration during preservation in the frozen state. For such a reason, it is said that heating for inactivating the various oxidizing enzymes in the texture before freezing, i.e., so-called blanching, is essential for most kinds of vegetables (see “Reitoshokuhin no Riron to Ouyou (Theory and Applications of Frozen Foods”).

Since the texture is also collapsed during the blanching or upon freezing after the blanching, deterioration of texture and dripping of water caused by freezing and thawing have been experienced as problems in the process of producing high-quality frozen vegetables.

The deterioration of texture after freezing and thawing is one of the serious problems causing a deterioration of overall product quality of frozen vegetables. In particular, when frozen vegetables are thawed and eaten in a raw condition like salad, there occurs a problem called a dripping phenomenon in which free water is separated and dripped at the time of thawing. It is reported that such a problem can be avoided and good texture can be kept even after the thawing by preheating some kinds of vegetables, such as radishes, carrots, lotus roots, cabbages, and kidney beans, so as to activate pectin and harden the texture (“New Food Industry”, Vol. 30, No. 4 p60-72 (1988)), or by adjusting the pH value of a blanching solution to about 4 so as to harden pectin (“Journal of the Japanese Society of Nutrition and Food Science”, Vol. 36, No. 4 p219-224 (1983)). However, the kinds of vegetables for which those methods are effective is limited. Another proposed method of reducing an amount of water to keep good texture even after the thawing is also used, in which tissues of vegetables are dehydrated by vaporizing water from the tissue utilizing, e.g., residual heat after the blanching, and reducing the content of free water in the tissue to protect the tissue from being collapsed with growth of ice crystals caused by freezing (“Reito (Freezing)”, Vol. 63, No. 723, 2-9 (1988)). With such a method, however, the amount of water cannot be reduced to a sufficiently low level, particularly, in leaf vegetables, such as bok-choy (pak-choi), in which the stalk texture is relatively hard and has a high water content, or fruit and stem vegetables in which the sarcocarp has a higher water content than root vegetables. Thus, the proposed method is effective in keeping texture to some extent, but if maintaining of more satisfactory texture is demanded, equipment for forced drying would be needed and an increase of the cost could be a problem. In addition, as methods being effective to keep good texture after freezing and then thawing, there are also reported a method of immersing vegetables in sugar before or after the blanching (“Reito (Freezing)”, Vol. 63, No. 723, 2-9 (1988)) and Japanese Patent Laid-Open Publication No. Hei 5-103587) or immersing vegetables in an antifreeze, e.g., sugar-alcohol or alcohol and potassium chloride (Japanese Patent Laid-Open Publication No. Sho 62-14264), and another method of pressurizing the vegetables under hydrostatic pressure after the above immersing step (Japanese Patent Laid-Open Publication No. Hei 5-252891). Those methods, however, have a disadvantage that the tastes intrinsic to the vegetables are impaired.

### DISCLOSURE OF THE INVENTION

It is an object of the present invention to provide a frozen vegetable capable of keeping good texture after freezing and then thawing.

Another object of the present invention is to provide a cooked vegetable in which a deterioration of texture is suppressed.

Still another object of the present invention is to provide a frozen vegetable capable of keeping good texture, which are generally eaten after being thawed and cooked, or in a raw condition like salad.

Still another object of the present invention is to provide a vegetable in which a deterioration of texture is suppressed during distribution in a chilled state after thawing.

To achieve the above objects, tests were carried out on means for suppressing collapse of the tissue caused by growth of ice crystals upon freezing, which is the main cause of deterioration of the texture after freezing and thawing, with the intent to find out the blanching means for inactivating oxidizing enzymes while suppressing the tissue collapse. Then, the inventors tried to suppress the tissue collapse by using boiled water, steam, an ohmic heating, microwaves, and superheated steam as the blanching means. As a result, the inventors have found out that, by blanching vegetables with the use of superheated steam among those blanching means, it is possible to inactivate the enzymes while suppressing the texture collapse, and hence to achieve the intent mentioned above.

In other words, the inventors have found out that, by employing superheated steam to blanch vegetables, the enzymes can be inactivated while suppressing the tissue collapse, and a deterioration of the texture after freezing and thawing can be held down. The expression “deterioration of the texture” mentioned here means softening of the texture, enhanced water release (i.e., watery texture) caused by separation and flowing out of water in chewing, i.e., a dripping phenomenon (less retention of water), and change into the porous and sponge-like form. Further, in the present invention, the term “cooked vegetable foods” means foods subjected to a cooking treatment under heating, including the blanching step that is essential, before the freezing.

Accordingly, the present invention resides in vegetables in which peroxidase has been inactivated by superheated steam, frozen products of the vegetables, or thawed products thereof which are adaptable for distribution in a chilled state.

Also, the present invention resides in vegetables which have been sterilized and in which peroxidase has been inactivated by using superheated steam, frozen products of the vegetables, or thawed products thereof which are adaptable for distribution in a chilled state.

Further, the present invention resides in cooked vegetable foods which have been sterilized and in which peroxidase has been inactivated by a cooking treatment with the use of superheated steam, whereby a deterioration of texture is suppressed, more specifically, whereby a deterioration of texture, which is attributable to softening of the texture, enhanced water release caused by separation and flowing out of water in chewing, and change into the porous and sponge-like form, is suppressed after freezing and thawing. In addition, the present invention resides in frozen products of the cooked vegetables, or thawed products thereof which are adaptable for distribution in a chilled state.

### BRIEF DESCRIPTION OF THE DRAWINGS

FIG. 1 is, in place of a drawing, a photograph of a frozen vegetable subjected to blanching by simple steaming and blanching by superheated steam, taken by a scanning electron microscope (upper photograph representing a vegetable blanched by simple steaming and lower photograph representing a vegetable blanched by superheated steam).

FIG. 2 is a graph showing changes of core temperature of paprika with a heating time in the blanching by simple steaming and superheated steam.

### BEST MODE FOR CARRYING OUT THE INVENTION

While vegetables to which the present invention is applied are not limited to particular ones, the vegetables are selected from the group consisting of eggplants(Nasu-rui), Welsh onions(Negi-rui), beans(Mame-rui), leaf vegetables(Sai-rui) and soft vegetables(Juusai) (based on Classification of Vegetables in Japan specified in “Shin Sosai Engeigaku (New Vegetable Floriculture)”, by Yoshio Suzuki and Yasukichi Takano, Asakura Co., Ltd.). More specifically, the vegetables are selected from the group consisting of paprika, asparagus, garlic buds, kidney beans, Chinese cabbages, onions, cabbages and broccoli. This is because the present invention is effective for green vegetables(Sai-rui) such as Chinese cabbages, cabbages and broccoli, condiment vegetables(Koshin-rui) such as celery, onions(Negi-rui) such as a Welsh onion, an onion and a garlic bud, eggplants(Nasu-rui) including paprika, soft vegetables(Juusai) such as asparagus, and beans(Mame-rui) such as a kidney bean, which cannot be sufficiently dehydrated after blanching. In other words, the present invention is intended for a novel blanching capable of inactivating enzymes while evidently holding the texture structure after heating.

The cooked vegetable foods of the present invention include the form of frozen products or thawed products thereof which are adaptable for distribution in a chilled state.

The cooked vegetable foods of the present invention are produced through a cooking treatment, including blanching, carried out on the vegetables mentioned above. In order to produce cooked vegetable foods keeping good texture after freezing and thawing, the cooked vegetable foods are produced by the blanching process capable of suppressing dripping and keeping good texture after thawing and during subsequent preservation in a chilled state.

The cooking treatment, including blanching, is preferably cooking under heating by superheated steam. The cooked vegetable foods of the present invention is produced with the cooking treatment carried out on the above-mentioned vegetables by using superheated steam.

The superheated steam is employed under a condition of not lower than 100° C. The blanching time is not limited to a particular value, but it is preferably set to the shortest time required for inactivating the oxidizing enzymes. For example, when the amount of superheated steam generated is about 80 kg/m² per one hour, the blanching at 200° C. is 25 seconds for 40 g of paprika and 2 minutes for 40 g of cabbage. An index enzyme used for determining the blanching time is selected here as an activity of peroxidase that is abundantly present in plants and is relatively highly endurable against heat.

The treatment for realizing the effect of keeping good texture is not limited to a simple treatment using superheated steam alone, but it may also be carried out in combination with a step of immersing the vegetables an aqueous solution of an additive, preferably sugar or sugar-alcohol, before or after heating.

Cooling and freezing steps subsequent to the heating are not limited to particular ones so long as those steps are carried out in ordinary manners. Air-blow cooling is preferably employed in the cooling step subsequent to the blanching.

The frozen vegetables of the present invention are eaten after being thawed and then treated under heating, i.e., cooked, or in a raw condition like salad.

An index for the enzyme activity to be measured is evaluated here as follows. The vegetable texture of interest is reacted with o-methoxy-phenol (guaiacol) and 0.03% of hydrogen peroxide. When the solution develops a color, it is determined that the enzyme activity exits in the tissue, and when the solution develops no color, it is determined that the enzyme is inactivated.

An index for the hardness to be measured is evaluated here by using a tensipressor made by Taketomo Electric Co., Ltd. More specifically, a predetermined plunger is caused to penetrate into the vegetable tissue of interest at a predetermined penetration speed by a predetermined distance. Then, a breakage stress (N/cm²) imposed on the plunger at that time is determined as the hardness.

An index for the dripping to be measured is evaluated here by putting a predetermined amount of tissue piece in a centrifugal separator and rotating the centrifugal separator at 250 G for 6 minutes. Then, an amount (%) of water separated from the tissue per wet unit weight is determined as indicating a centrifugal dripping.

In more detail, heated frozen vegetables keeping good texture after freezing and thawing, according to the present invention, have properties featured in that, taking paprika as an example, the breakage stress (N/cm²) of the tissue after freezing and then thawing is not less than 15 and the centrifugal dripping amount is not more than 50 g per 100 g wet weight.

The present invention will be described in more detail below in connection with Examples. It is to be noted that the present invention is limited in no way by the following Examples.

### EXAMPLE 1

The texture after thawing of the frozen vegetables produced through blanching by simple steaming and blanching by superheated steam was compared for paprika.

Paprika having sarcocarp with a thickness of 4 mm and red pericarp was employed as a sample and cut into tissue specimens each having a size of 1.5×2 cm. The blanching by simple steaming was performed with a cooker for domestic uses. After steaming 40 g of the sample by steam at 100° C. for 40 seconds, i.e., a minimum heating time required for inactivating the oxidizing enzymes by the steam, the sample was dewatered and cooled by blown air. After the sample temperature was lowered down to 30° C., the sample was frozen at −30° C. and preserved for several days. Then, the frozen sample was thawed at the room temperature. The amount of steam used for the blanching by simple steaming was set to a steam amount produced from water of 92 kg/hour per heating area of 1 m². The blanching by superheated steam was performed with a step of heating 40 g of the sample by superheated steam at 200° C. for 25 seconds, i.e., a minimum heating time required for inactivating the oxidizing enzymes by the superheated steam. The subsequent steps were the same as those in the case of the blanching by simple steaming. The amount of steam used for the blanching by the superheated steam was set to a steam amount produced from water of 207 kg/hour per heating area of 1 m².

Values of the hardness were measured by using the tensipressor as follows.

A measuring method comprises the steps of placing each paprika specimen with the sarcocarp facing upward, penetrating a cylindrical plunger with a diameter of 8 mm into the sarcocarp from above at a speed of 0.1 mm/sec and at a distortion rate of 60% (by a distance of 3.2 mm when the sarcocarp has a thickness of 4 mm), and determining the breakage stress (N/cm²) imposed on the plunger at that time as an index of the hardness. The measurement was made on 15 specimens for each test group. The measured values are shown in Table 1 as given below.

TABLE 1

| | Breakage Stress (N/cm²) |
|---|---|
| Superheated steam | 21 ± 4 |
| Simple steaming | 9 ± 1 |

mean value ± standard deviation

Values of the centrifugal dripping were measured as follows.

A measuring method comprises the steps of cutting paprika into tissue specimens each having a size of 5×5 mm, preparing two test groups each including 5 specimens, and making the measurements of 5 specimens for each test group. The measured values are shown in Table 2 as given below.

TABLE 2

| | Centrifugal Dripping (%) |
|---|---|
| Superheated steam | 40 ± 4 |
| Simple steaming | 55 ± 3 |

mean value ± standard deviation

A sensory test (with a test panel consisted of 10 members) was carried out on the frozen vegetables that were produced through the blanching by simple steaming and the blanching by superheated steam, and were thawed at the room temperature. The evaluation was made based on three-stage scales, i.e., “texture remained the same”, “texture was slightly improved”, and “texture was markedly improved” in comparison with the vegetables blanched by simple steaming. As a result, all the panel members replied “texture was markedly improved in comparison with the blanched by simple steaming”.

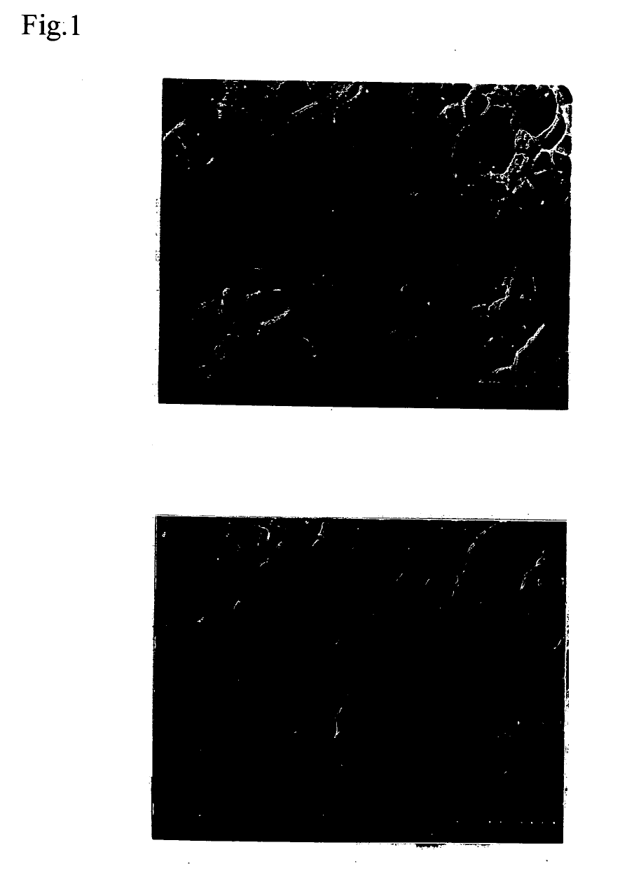

From the above results, it was made apparent that, when producing frozen paprika, texture of the paprika after thawing was improved with the blanching by superheated steam. To clarify the cause of such an improvement of texture, the textures of the frozen vegetables produced through the blanching by simple steaming and the blanching by superheated steam were observed by using a scanning electronic microscope. The observed results are shown in FIG. 1. It is seen from the photographs of FIG. 1 that cell walls of the vegetables blanched by superheated steam are less collapsed than the vegetables blanched by simple steaming.

The scanning electronic microscope used for observing the textures was Model S-3200N (generally called Natural-SEM) made by Hitachi, Ltd., which enables the texture to be observed, as it is, with no need of fixing it in place. A paprika specimen (in the cubic form of about 5 mm) was frozen by liquefied nitrogen and then observed. The observation conditions were set to a vacuum degree of 30 Pa and at magnifications of 60 times.

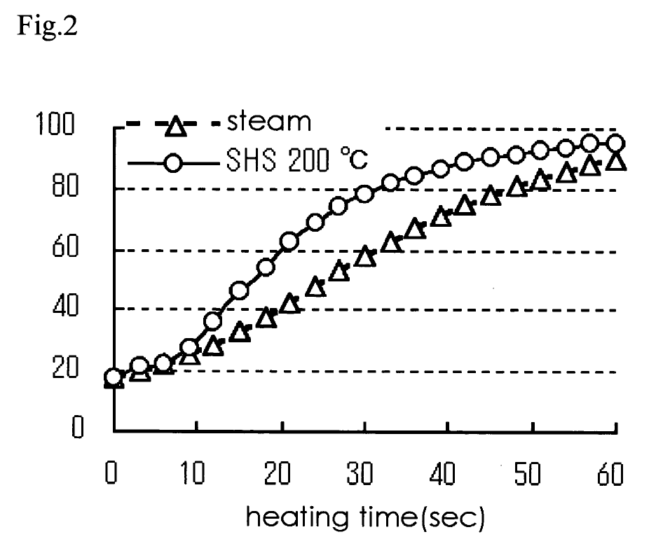

Further, a measurement was made for changes of the respective core temperatures with the blanching time of paprika subjected to simple steaming and superheated steam. The measured results are plotted in FIG. 2. As seen from FIG. 2, the core temperature of the paprika under the test was increased by the superheated steam at a higher speed than by the simple steaming. The time required for the core temperature to reach 70° C. was 40 seconds in the case of the simple steaming, and was 25 seconds in the case of the superheated steam.

From the above-mentioned results of the texture observation and the above-mentioned difference in changes of the core temperature with the blanching time, it is thought that the blanching by superheated steam provides a higher effect of keeping good texture for the reason as follows. Because the core temperature of the paprika was increased by the superheated steam at a higher speed than by the simple steam, the peroxidase activity in the texture is inactivated at an earlier point in time. As a result, in the frozen paprika having been subjected to the blanching by superheated steam, the blanching can be completed in the stage in which the structure collapse is not so progressed. Thus, the blanching by superheated steam is more effective in keeping good texture.

It is thought that the texture of frozen vegetables varies during preservation in a frozen state. To further examine the texture keeping effect of the blanching by superheated steam, therefore, the frozen cut paprika prepared in Example 1, i.e., two groups of the frozen paprika produced through the blanching by simple steaming and the blanching by superheated steam, were preserved at −10° C. and −20° C.

The changes in measured values of the hardness resulting from the case of preserving the frozen paprika at −10° C. are shown in Table 3 given below, and the changes in measured values of the hardness resulting from the case of preserving the frozen paprika at −20° C. are shown in Table 4 given below. The hardness was measured by using a tensipressor in the same manner as that described above in connection with Example 1.

The changes in measured values of the centrifugal dripping resulting from the case of preserving the frozen paprika at −10° C. are shown in Table 5 given below, and the changes in measured values of the centrifugal dripping resulting from the case of preserving the frozen paprika at −20° C. are shown in Table 6 given below. The centrifugal dripping was measured in the same manner as that described above in connection with Example 1.

TABLE 3

| | Immediately | After | After |
|---|---|---|---|
| | after | preservation for | preservation for |
| | preparation | 1 month | 4 months |
| Superheated steam | 21 ± 4 | 19 ± 4 | 12 ± 4 |
| Simple steaming | 9 ± 1 | 7 ± 2 | 4 ± 1 |

mean value ± standard deviation

TABLE 4

| | Immediately | After | After |
|---|---|---|---|
| | after | preservation for | preservation for |
| | preparation | 2 months | 5 months |
| Superheated steam | 21 ± 4 | 22 ± 5 | 21 ± 4 |
| Simple steaming | 9 ± 1 | 8 ± 2 | 9 ± 1 |

mean value ± standard deviation

TABLE 5

| | Immediately | After | After |
|---|---|---|---|
| | after | preservation for | preservation for |
| | preparation | 1 month | 4 months |
| Superheated steam | 40 ± 4 | 39 ± 4 | 39 ± 3 |
| Simple steaming | 55 ± 3 | 54 ± 1 | 57 ± 1 |

mean value ± standard deviation

TABLE 6

| | Immediately | After | After |
|---|---|---|---|
| | after | preservation for | preservation for |
| | preparation | 1 month | 4 months |
| Superheated steam | 40 ± 4 | 39 ± 4 | 39 ± 3 |
| Simple steaming | 55 ± 3 | 54 ± 1 | 57 ± 1 |

mean value ± standard deviation

From the results of the preservation tests mentioned above, the following was confirmed with regards to the texture keeping effect of the blanching by superheated steam. The hardness was softened in both of the vegetables blanched by the simple steam and the vegetables blanched by the superheated steam during the frozen preservation at −10° C., the difference in the measured values was less changed in the vegetables blanched by the superheated steam than in the vegetables blanched by the simple steam. The hardness was not changed during the frozen preservation at −20° C. The measured values of the centrifugal dripping were not changed regardless of the temperature during the preservation. Thus, those results made it apparent that the texture keeping effect of the blanching by the superheated steam could be kept with the frozen preservation at −10° C. or below.

### EXAMPLE 2

The texture after thawing of frozen vegetables produced through the blanching by superheated steam and the blanching by simple steaming was compared using green asparagus. More specifically, green asparagus was employed as a sample and cut into a length of 9 cm from the tip. The blanching by simple steaming was performed with a cooker for domestic uses. After simple steaming 40 g of the sample by steam at 100° C. for 120 seconds, i.e., a minimum heating time required for inactivating the oxidizing enzymes by the steam, the sample was dewatered and cooled by blown air. After the sample temperature was lowered down to 30° C., the sample was frozen at −30° C. and preserved for several days. Then, the frozen sample was thawed at the room temperature. The amount of steam used for the blanching by simple steaming was set to a steam amount produced from water of 92 kg/hour per heating area of 1 m². The blanching by superheated steam was performed with a step of blanching 40 g of the sample at 200° C. for 120 seconds, i.e., a minimum heating time required for inactivating the oxidizing enzymes by the superheated steam. The subsequent steps were the same as those in the case of the blanching by simple steaming. The amount of steam used for the blanching by the superheated steam was set to a steam amount produced from water of 207 kg/hour per heating area of 1 m².

Values of the hardness were measured by using the tensipressor as follows.

A measuring method comprises the steps of cutting asparagus into round pieces each having a length of 1 cm, placing the round piece to lie horizontally, and penetrating a cylindrical plunger with a diameter of 5 mm into the round piece from above at a speed of 1 mm/sec by 80% of a total penetration distance (4 mm when the total penetration distance is 1 mm), and determining the breakage stress (N/cm²) imposed on the plunger at that time as an index of the hardness. The measurement was made on 15 specimens for each test group. The measured values are shown in Table 7 as given below.

TABLE 7

| | Breakage Stress (N/cm²) |
|---|---|
| Superheated steam | 9 ± 1 |
| Simple steaming | 6 ± 1 |

mean value ± standard deviation

Values of the centrifugal dripping were measured as follows.

A measuring method comprises the steps of cutting asparagus into round pieces having the same shape as those used in the above measurement of the hardness, preparing two test groups each including specimens, and making the measurements of 5 specimens for each test group. The measured values are shown in Table 8 as given below.

TABLE 8

| | Centrifugal Dripping (%) |
|---|---|
| Superheated steam | 42 ± 2 |
| Simple steaming | 46 ± 4 |

mean value ± standard deviation

A sensory test (with a test panel consisted of 10 members) was carried out on the frozen vegetables that were produced through the blanching by simple steaming and the blanching by superheated steam, and were thawed at the room temperature. The evaluation was made based on the same scales as those used in Example 1. As a result, three panel members replied “texture was markedly improved”, and six panel members replied “texture was slightly improved”.

From the above results, it was made apparent that, when producing frozen green asparagus, texture of the green asparagus after thawing was improved with the blanching by superheated steam. To clarify the cause of such an improvement of texture, pectin matters of the textures of the frozen vegetables produced through the blanching by simple steaming and the blanching by superheated steam were dyed by using the ruthenium red. The obtained results are shown in FIG. 2. It is seen from the results that decomposition of the pectin matters of the vegetables blanched by superheated steam is suppressed to a larger extent than the vegetables blanched by simple steaming.

Thus, it can be confirmed that, in both of the frozen paprika and the frozen asparagus, good texture is apparently kept even after thawing with the blanching by superheated steam. Also, as a result of the texture observation, it is proved that collapse of the texture (denaturation of the pectin matter before thawing) is suppressed with the heating by superheated steam.

### INDUSTRIAL APPLICABILITY

The present invention is able to provide cooked frozen vegetable foods capable of keeping satisfactory hardness and suppressing water dripping after freezing and thawing and further during subsequent preservation in a chilled state.

1. Vegetables wherein peroxidase has been inactivated or its activity is lowered by superheated steam.

2. Vegetables according to claim 1, wherein the vegetables are in the form of frozen products.

3. Vegetables according to claim 1, wherein the vegetables are products which are thawed from frozen vegetables and are adaptable for distribution in a chilled state.

4. Vegetables according to claim 1, wherein the vegetables are selected from the group consisting of eggplants, Welsh onions, beans, leaf vegetables and soft vegetables.

5. Vegetables according to claim 1, wherein the vegetables are selected from the group consisting of paprika, asparagus, garlic buds, kidney beans, Chinese cabbages, onions, cabbages and broccoli.

6. Vegetables which have been sterilized and in which peroxidase has been inactivated by using superheated steam.

7. Vegetables according to claim 6, wherein the vegetables are in the form of frozen products.

8. Vegetables according to claim 6, wherein the vegetables are products which are thawed from frozen vegetables and are adaptable for distribution in a chilled state.

9. Vegetables according to claim 6, wherein the vegetables are selected from the group consisting of eggplants, Welsh onions, beans, leaf vegetables and soft vegetables.

10. Vegetables according to claim 6, wherein the vegetables are selected from the group consisting of paprika, asparagus, garlic buds, kidney beans, Chinese cabbages, onions, cabbages and broccoli.

11. Cooked vegetable foods suffering from less worsening in texture, which have been sterilized and in which peroxidase has been inactivated by a cooking treatment with the use of superheated steam.

12. Cooked vegetable foods according to claim 11, wherein the worsening in texture is attributable to softening of the texture, enhanced water release caused by separation and flowing out of water in chewing, and change into the porous and sponge-like form after freezing and then thawing.

13. Cooked vegetable foods according to claim 11, wherein the vegetable foods are in the form of frozen products.

14. Cooked vegetable foods according to claim 11, wherein the vegetable foods are products which are thawed from frozen vegetables and are adaptable for distribution in a chilled state.

15. Cooked vegetable foods according to claim 11, wherein the vegetable foods are selected from the group consisting of eggplants, Welsh onions, beans, leaf vegetables and soft vegetables.

16. Cooked vegetable foods according to claim 11, wherein the vegetable foods are selected from the group consisting of paprika, asparagus, garlic buds, kidney beans, Chinese cabbages, onions, cabbages and broccoli.
